(19) United States
(12) Patent Application Publication
(10) Pub. No.: US 2013/0216388 A1
(43) Pub. Date: Aug. 22, 2013

(54) BOX-SHAPED SHEAR WEB FOR WIND TURBINE BLADES AND METHOD OF MAKING

(71) Applicants: Afroz Akhtar, Bangalore (IN); Prasad Ogde, Bangalore (IN); Jaish Mathew, Bangalore (IN)

(72) Inventors: Afroz Akhtar, Bangalore (IN); Prasad Ogde, Bangalore (IN); Jaish Mathew, Bangalore (IN)

(73) Assignee: GENERAL ELECTRIC COMPANY, Schenectady, NY (US)

(21) Appl. No.: 13/400,252

(22) Filed: Feb. 20, 2012

(51) Int. Cl. F03D 1/06; B23P 11/00; B29C 53/56

(52) U.S. Cl. 416/226; 264/257; 29/428

(57) ABSTRACT

A wind turbine blade includes a pressure side shell member with an internal side spar cap, and a suction side shell member with an internal side spar cap. A box-shaped shear web assembly spans between the spar caps and has a generally hollow interior volume. The shear web assembly includes end walls affixed to a respective spar cap and spaced-apart side walls extending transversely between the end walls. The end walls and side walls define a continuous box-shaped assembly structurally interposed between the spar caps. Methods are also provided for making the box-shaped shear web assembly.

### FIELD OF THE INVENTION

The present disclosure relates in general to wind turbine blades, and more particularly to an internal shear web configuration for a wind turbine blade.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

As wind turbines increase in size and rotor height, the costs and logistics associated with constructing the turbine blades grow proportionately, and the industry is continuously seeking new constructions that are lighter, stronger, and more economical.

The main function of a shear web in a wind turbine rotor blade is to keep the pressure and suction side shell members from collapsing and for transferring shear stresses from one shell to the other. The thickness of the shear web is limited by the buckling strength of the web and the bond length between the shear web and spar cap required to maintain the shear web in position. Often, shear clips are added to increase this bond length. However, placement of the shear clips is done after closure of the blade shells, which is a difficult and time consuming process, and full-length placement of shear clips depends on accessibility of the shear web/spar cap interface.

A shear web construction would be welcome in the art that is robust, uses less material, and provides a significantly improved bond length between the shear web and spar caps.

### BRIEF DESCRIPTION OF THE INVENTION

Aspects and advantages of the invention will be set forth in part in the following description, or may be obvious from the description, or may be learned through practice of the invention.

In accordance with aspects of the invention, a wind turbine blade includes a pressure side shell member with an internal side spar cap, and a suction side shell member with an internal side spar cap. The pressure and suction side shell members are joined at a leading and trailing edge of the blade. A box-shaped shear web assembly spans between the spar caps and has a generally hollow interior volume. The shear web assembly includes end walls affixed to a respective spar cap by glue or other suitable bonding materials, and spaced-apart side walls extending transversely between the end walls. The end walls and side walls define a continuous box-shaped assembly structurally interposed between the spar caps.

In a particular embodiment, the side walls have a lighter weight material core, which may be any suitable high shear modulus/high strength materials, such as foam, balsa wood, and so forth. For example, the shear web assembly may include at least one inner box member that is circumscribed by and an outer box member, with the material core disposed between sides of the inner and outer box members. The material core may also be disposed between the end sides of the inner and outer box members such that the material core defines a generally continuous ring between the inner and outer box members. In an alternate embodiment, the inner box member may be joined directly to the outer box member at the end sides of the respective box members.

In a further embodiment, the shear web assembly may include two inner box members joined at a central wall extending through the interior volume of the shear web assembly. Alternatively, the inner box member may be formed from separate components that are attached to together, for example separate C-shaped partial box members joined to define a continuous box member.

The inner and outer box members may be separately formed and subsequently joined with the material core placed between the sides of the inner and outer box members. For example, the material core may be injected between the sides of the inner and outer box members. Alternatively, the material core may be separately formed as panels that are placed between the sides of the inner and outer box members.

In still a further embodiment, the material core pieces are placed between the side walls and end walls of the inner and outer box members.

The box members may be variously formed. For example, the end walls and side walls may be defined by an outer box member formed by a continuously wound bi-axial fiber layer. The inner box member may also be formed by a continuously wound bi-axial fiber layer, wherein the material core is placed between the sides of the inner and outer box members. For example, the material cores may be attached to the sides of the inner box member, with the outer box member being wound as a bi-axial fiber layer around the inner box member and attached material cores.

The wind turbine blade may include any number of the separately formed shear web assemblies longitudinally connected together along the length of said blade.

The present invention also encompasses various method embodiments for making the shear web assemblies. A particular method embodiment includes forming an inner box member and forming an outer box member around the inner box member with a space between respective sides of the inner and outer box members. Material core pieces, such as foam pieces, are disposed in the space between the sides of the inner and outer box members.

In a particular method embodiment, the inner box member is formed by winding one or more fiber layers around a mandrel. Foam material core pieces are placed on the mandrel against the wound inner box member and the outer box member is subsequently formed by continuing to wind one or more fiber layers with the mandrel around the inner box member and foam material core pieces. The inner and outer box members may be wound as bi-axial fiber layers.

In forming the shear web assemblies with a mandrel, the method may include collapsing the mandrel to remove the wound shear web assembly from the mandrel. For example, the mandrel may be formed from an inner axial component flanked by outer axial components, whereby the mandrel is collapsed by removing the inner axial component from the mandrel.

In an alternative method embodiment, the inner and outer box members may be separately formed, with the inner box member being subsequently placed within the outer box member. Material core pieces are then disposed between the sides of the inner and outer box members.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a conventional wind turbine with a plurality of turbine blades;

FIG. 2 is a perspective view of a wind turbine blade with an internal shear web assembly in accordance with aspects of the invention;

FIG. 3 is a cross-sectional view of a turbine blade with an embodiment of a shear web assembly;

FIG. 4 is a side cross-sectional view of a particular embodiment of a shear web assembly;

FIG. 5 is a partial assembly view of an embodiment of a shear web assembly;

FIG. 6 is a further assembly view of the embodiment of FIG. 5;

FIG. 7 is a side cross-sectional view of another embodiment of a shear web assembly;

FIG. 8 is a side cross-sectional view of still a further embodiment of a shear web assembly;

FIG. 9 is a side cross-sectional view of a different embodiment of a shear web assembly;

FIG. 10 is a perspective view of a winding mandrel that may be used in a method for forming shear web assemblies in accordance with aspects of the invention; and

FIG. 11 is a perspective view of a winding machine that may be used in a method for forming shear web assemblies in accordance with aspects of the invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

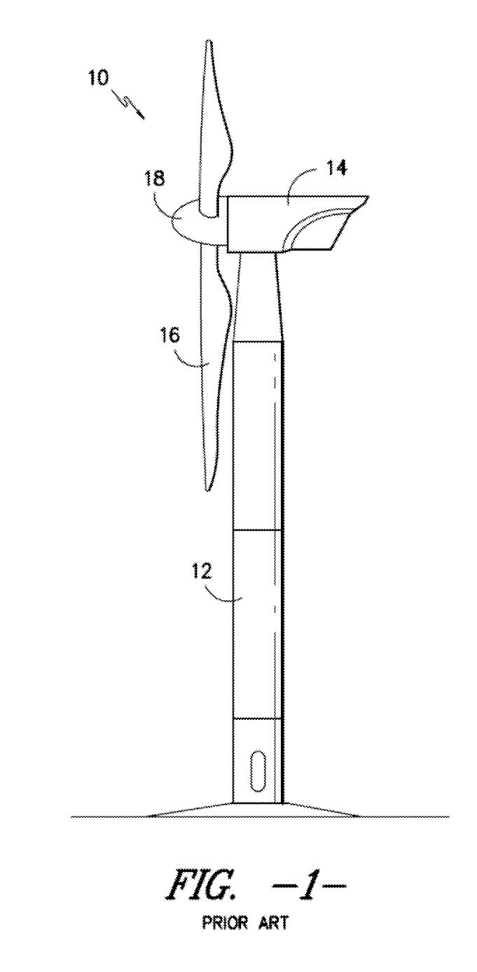

FIG. 1 illustrates a wind turbine 10 of conventional construction. The wind turbine 10 includes a tower 12 with a nacelle 14 mounted atop the tower. A plurality of rotor blades 16 are mounted to a rotor hub 18, which is in turn connected to a main flange that turns a main rotor shaft (within the nacelle 14). The wind turbine power generation and control components are housed within the nacelle 14. The view of FIG. 1 is provided for illustrative purposes only to place the present invention in an exemplary field of use. It should be appreciated that the invention is not limited to any particular type of wind turbine tower configuration or tower-top component intended to be mounted atop the tower.

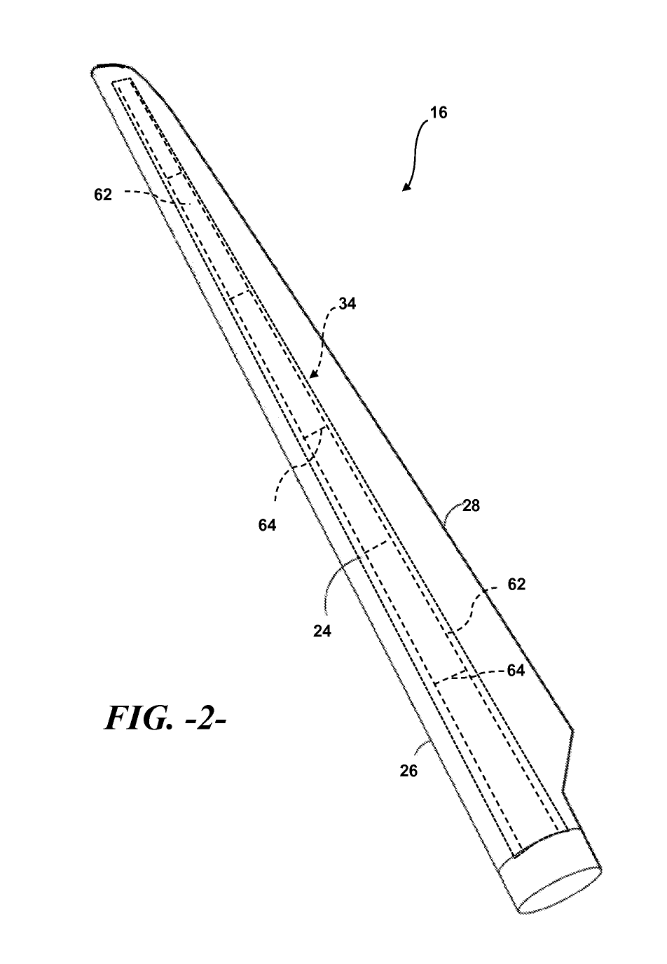

FIG. 2 depicts a rotor blade 16 in greater detail. The blade 16 is formed by a pressure side shell member 22 that is joined to a suction side shell member 24 along a leading edge 26 and a trailing edge 28, as in well-known in the art. The blade 16 includes internal structural members that separate the shell members 22, 24 and transfer shear forces between the shell members 22, 24. In conventional constructions, this internal structure includes spar caps affixed to the inner faces of the shell members 22, 24, and a shear web that spans between the spar caps, typically in a beam-like configuration. Blades 16 in accordance with aspects of the present invention include a shear web assembly 34 that is uniquely configured as set forth herein.

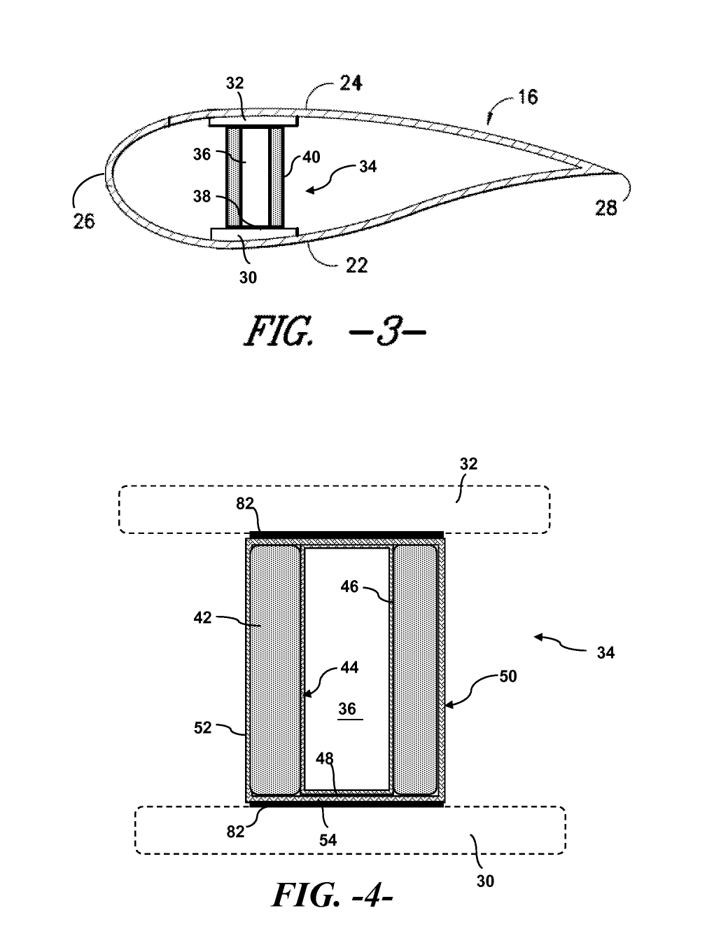

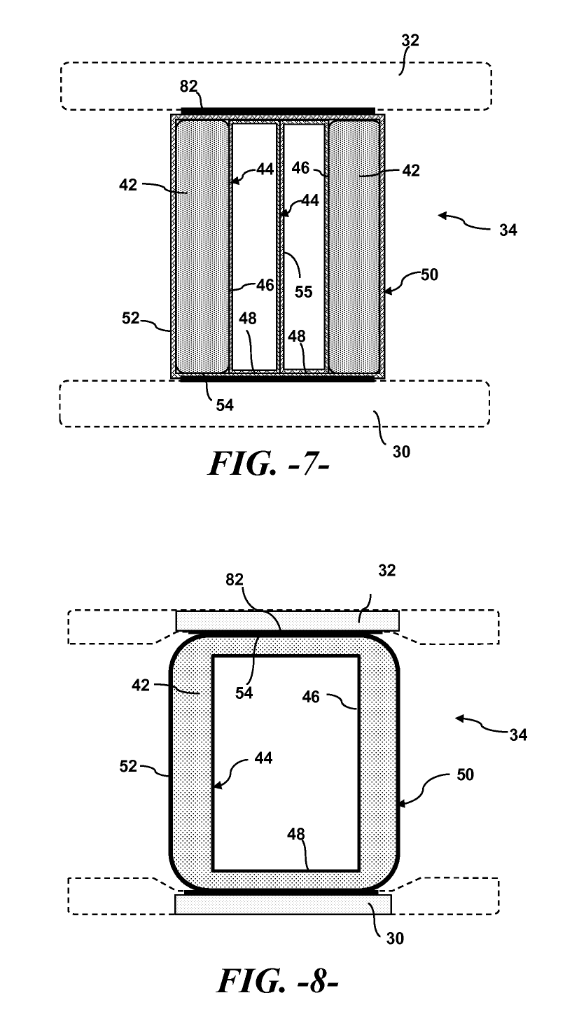

Referring to FIGS. 3 and 4 in general, a shear web assembly 34 in accordance with aspects of the invention is a box-shaped component that spans between the spar caps 30, 32. The shear web assembly 34 has a generally hollow interior 36. The interior 36 is considered generally hollow in that it does not contain a core material and is generally an open space. The interior 36 may include structural members within the hollow space, as depicted in the embodiment of FIG. 7 and described in greater detail below.

Referring to FIG. 3, the shear web assembly 34 includes end walls 38 that are affixed to the respective spar caps 30, 32 by any conventional means, including mechanical means, adhesives, bonding techniques, and so forth. The shear web assembly 34 also includes spaced-apart side walls 40 extend between the end walls 38. With this configuration, the end walls 38 and side walls 40 form a continuous box-shaped structural assembly interposed between the spar caps 30, 32.

It should be appreciated from the general embodiment of FIG. 3 that the shear web assembly 34 does not form a box-like structure with the spar caps 30, 32 defining the ends of the structure, but is a complete box-like structure with its own independent end walls 38 that are affixed to the spar caps 30, 32 by glue or other suitable bonding material 82 (FIG. 4).

Still referring to FIGS. 3 and 4, in a particular embodiment of the shear web assembly 34, the side walls 40 include an interior material core 42. This material core 42 may be any suitable light weight structural material having a high shear modulus/shear strength, such as wood (particularly balsa wood) or foam, including the type of foam material used in the construction of conventional beam-like shear webs known in the art. It should be appreciated that the shear web assembly 34 is not limited to any particular type or brand of core material used for the side wall cores 42.

The material core 42 may be incorporated into the side walls 40 by various construction means. For example, referring particularly to the embodiment of FIG. 4, the shear web assembly 34 may include at least one inner box member 44 that is circumscribed by an outer box member 50, with the foam material core 42 disposed between the respective sides 46 of the inner box member 44 and sides 52 of the outer box member 50. The material core 42 may be injected into the space between the sides 46, 52 in one embodiment, or separately formed and placed within the space between the sides of the inner box member 44 and outer box member 50.

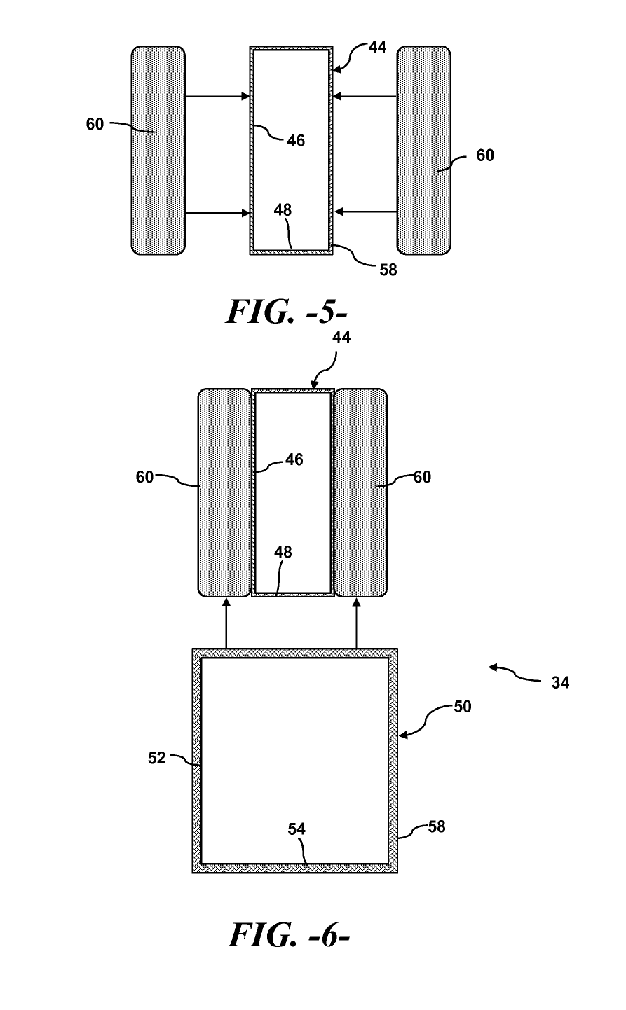

For example, referring to the partial assembly views of FIGS. 5 and 6, the inner box member 44 may be separately formed from any suitable material, including laminate materials, composite materials, fiber materials, and so forth. In the embodiment depicted in FIG. 5, the inner box member 44 is formed from one or more fiber layers 58, and in a particular embodiment may be a bi-axially wound fiber layer, as described in greater detail below. Material core panels 60 (e.g., foam panels) may be separately formed and adhered to the sides 46 of the inner box member 44, as depicted by the arrows in FIG. 5.

FIG. 6 depicts the inner box member 44 with the foam core panels 60 attached to the sides 46. The outer box member 50 may be a separately formed member of the same or different materials used to form the inner box member 44. In the depicted embodiment, the outer box member 50 is also a bi-axially wound fiber layer material. FIG. 6 depicts the outer box member 50 being separately fitted to the inner box/foam core panel assembly to complete the shear web assembly 34.

Although not depicted in the figures, it should be readily appreciated that, in an alternate embodiment, the inner box member 44 may be placed within the outer box member 50 with a space between the respective side walls of the boxes 44, 50. In this embodiment, the material core 42 may then be injected into the space between the box members 44, 50, or separately formed material core panels 60 may be fitted into the spaces between the boxes 44, 50.

As can be appreciated from the embodiments depicted in FIGS. 4 and 7, the end sides 48 of the inner box member 44 may be directly affixed to the end sides 54 of the outer box member 50 by any suitable means.

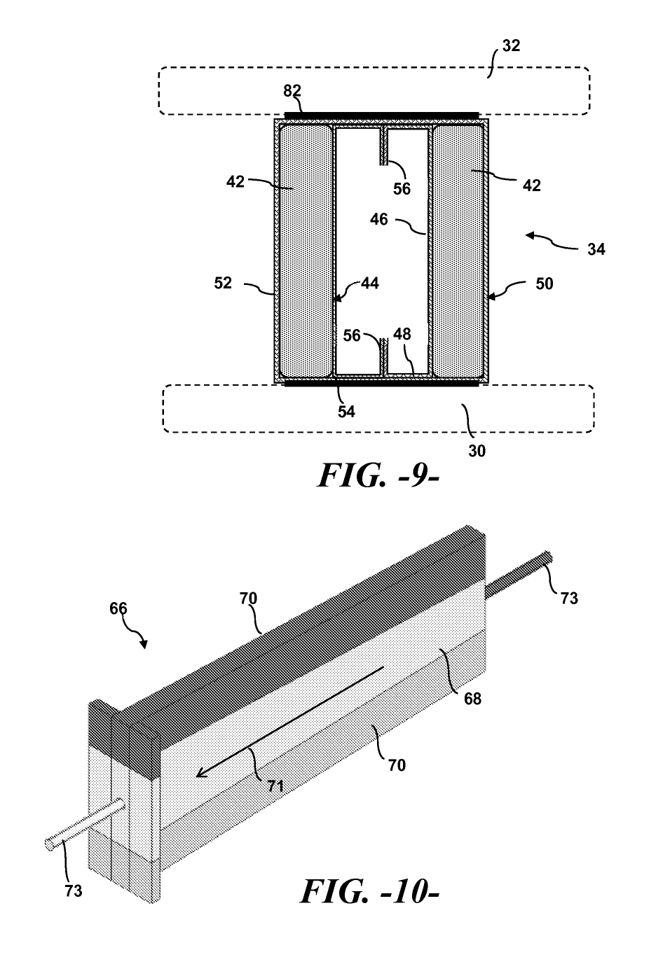

In an alternate embodiment depicted, for example, in FIG. 8, the material core 42 extends between the end sides 48, 54 so as to form a generally continuous ring between the outer box member 50 and inner box member 44. This embodiment may be particularly useful when used in combination with a carbon spar caps 30, 32 (or other high modulus material) in that the extra core material at the end side walls further supports and prevent buckling of the spar caps. Thus, less of the more costly spar cap material is needed to suppress buckling.

The inner box member 44 may be variously configured. For example, in the embodiment of FIG. 7, two separate box members 44 are provided and are joined together along a central support wall 55 disposed within the interior volume of the shear web assembly 34. It should be appreciated that any number of boxes may be joined together to define the overall inner box member 44.

In the embodiment of FIG. 9, the inner box member 44 is defined by separately formed C-shaped partial boxes 56 having separate respective ends 48 affixed to the end sides 54 of the outer box member 50.

Referring to FIG. 2, it should be appreciated that the shear web assembly 34 may be provided within the wind turbine blades 16 as a single component, or a plurality of individually formed segments 62 oriented longitudinally within the blade 16 and connected together at longitudinal ends 64 along the length of the blade 16. This configuration may be beneficial in that the individual segments 62 can be formed to more readily accommodate the overall taper and curvature of the blade 16 from the root to the tip of the blade.

The present invention also encompasses various method embodiments for forming a box-shaped shear web assembly 34 in accordance with aspects of the invention. For example, as discussed above, the inner 44 and outer 50 box members may be separately formed from any suitable material, with the inner box member 44 being placed within the outer box member 50. The material core 42 may be injected between the sides of the boxes, or separately formed as core panel pieces 60 and placed within the space between the sides of the respective boxes 44, 50.

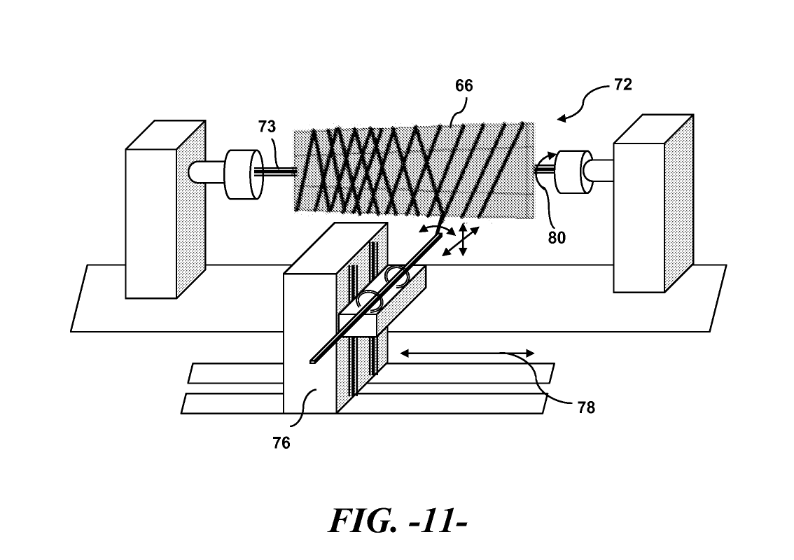

With the embodiments of FIGS. 5 and 6, for example, the inner box member 44 may be formed in a winding process around a mandrel 66 depicted in FIG. 10. The mandrel 66 may include winding end axles 73. The mandrel 66 may be used in a conventional winding machine 72 depicted in FIG. 11 wherein the mandrel 66 is held by the axles 73 and rotated in the directional arrow 80. A fiber carrier 76 conducts a continuous fiber 74 in a back-and-forth motion along the mandrel 66, as depicted by the directional arrow 78. Thus, as the mandrel 66 rotates and the fiber carrier 76 traverses in the back-and-forth motion, the fiber 74 is wound as a bi-axial layer onto the mandrel 66.

With the shape of the mandrel 66 depicted in FIG. 10, it should be appreciated that a bi-axial fiber layer box is formed as the inner box member 44. Once the fiber layer 58 (FIG. 5) is at its designed thickness (or fiber layers), the foam core panel 60 may be attached to the fiber layer 58 along the sides of the mandrel 70. At this point the winding process may continue to form the outer box member 50 with the same bi-axial fiber layer as the inner box member 44.

Once the outer box member 50 is wound onto the mandrel 66 (around the foam core panels 60 and end sides 48 of the inner box member 44), the mandrel may be collapsed and removed from the shear web assembly 34. For example, referring to the mandrel 66 depicted in FIG. 10, the mandrel may include a center or inner component 68 that is flanked on either side by outer tapered components 70. Removal of the inner component 68 along the line 71 from between the outer components 70 allows the mandrel 66 to collapse within the previously wound inner box member 44 and, thus, easily removed from the shear web assembly structure.

It should be appreciated that the mandrel winding process described and illustrated herein is just one of a number of suitable methods that may be utilized to form a shear web assembly 34 in accordance with aspects of the invention, and that the invention is not limited to this particular method of construction.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A wind turbine blade, comprising:
a pressure side shell member with an internal side spar cap;
a suction side shell member with an internal side spar cap, said pressure and suction side shell members joined at a leading and trailing edge of said blade;
a box-shaped shear web assembly spanning between said spar caps, said shear web assembly having a generally hollow interior volume and further comprising:
end walls affixed to a respective said spar cap;
spaced-apart side walls extending transversely between said end walls;
and wherein said end walls and said side walls define a continuous box-shaped assembly structurally interposed between said spar caps.

2. The wind turbine blade as in claim 1, wherein said side walls comprise a lighter weight material core.

3. The wind turbine blade as in claim 2, wherein shear web assembly comprises at least one inner box member circumscribed by an outer box member, said material core disposed between sides of said inner and outer box members.

4. The wind turbine blade as in claim 3, wherein said inner box member is joined directly to said outer box member at end sides thereof to define said end walls of said shear web assembly.

5. The wind turbine blade as in claim 3, comprising two said inner box members joined at a central wall extending through said interior volume of said shear web assembly.

6. The wind turbine blade as in claim 3, wherein said inner box member comprises separate C-shaped partial box members joined to define a continuous box member.

7. The wind turbine blade as in claim 3, wherein said inner and outer box members are separately formed and subsequently joined with said material core placed between said sides of said inner and outer box members.

8. The wind turbine blade as in claim 7, wherein said material cores are injected between said sides of said inner and outer box members.

9. The wind turbine blade as in claim 7, wherein said material cores are separately formed and placed between said sides of said inner and outer box members.

10. The wind turbine blade as in claim 1, wherein said end walls and said side walls are defined by an outer box member formed by a continuously wound bi-axial fiber layer.

11. The wind turbine blade as in claim 10, wherein said shear web assembly comprises an inner box member formed by a continuously wound bi-axial fiber layer, and further comprising a lighter weight material core between sides of said inner and outer box members.

12. The wind turbine blade as in claim 11, wherein said material cores are attached to said sides of said inner box member, and said outer box member is wound as a bi-axial fiber layer around said inner box member and attached foam material cores.

13. The wind turbine blade as in claim 1, wherein said shear web assembly comprises a plurality of separately formed longitudinally extending pieces connected together along the length of said blade.

14. A wind turbine blade, comprising:
a pressure side shell member with an internal side spar cap;
a suction side shell member with an internal side spar cap, said pressure and suction side shell members joined at a leading and trailing edge of said blade;
a box-shaped shear web assembly spanning between said spar caps, said shear web assembly having a generally hollow interior volume and further comprising:
an inner box member circumscribed by and an outer box member
a lighter weight material core disposed between side walls and end walls of said inner and outer box members;
wherein said end walls are affixed to a respective said spar cap and end walls and said side walls of said outer box member define a continuous box-shaped assembly structurally interposed between said spar caps.

15. A method for making a box-shaped shear web assembly for a wind turbine blade, wherein the shear web assembly has end walls configured to attach to internal spar caps of pressure and suction side shell members of the wind turbine blade and spaced-apart side walls that extend transversely between the end walls, the method comprising:
forming an inner box member;
forming an outer box member around the inner box member with a space between respective sides of the inner and outer box members; and
disposing a lighter weight material core piece within the space between the sides of the inner and outer box members.

16. The method as in claim 15, further comprising forming the inner box member by winding one or more fiber layers around a mandrel, placing the material core pieces on the mandrel against the wound inner box member; and forming the outer box member by continuing to wind one or more fiber layers with the mandrel around the inner box member and foam material core pieces.

17. The method as in claim 16, further comprising winding the inner and outer box members as bi-axial fiber layers.

18. The method as in claim 16, further comprising collapsing the mandrel to remove the wound shear web assembly from the mandrel.

19. The method as in claim 18, wherein the mandrel is formed from an inner axial component flanked by outer axial components, whereby the mandrel is collapsed by removing the inner axial component from the mandrel.

20. The method as in claim 15, comprising separately forming the inner and outer box members, placing the inner box member within the outer box member, and disposing the material core pieces between the sides of the inner and outer box members.
